(19) United States
(12) Patent Application Publication
(10) Pub. No.: US 2007/0006134 A1
(43) Pub. Date: Jan. 4, 2007

(54) Data processing method compatible with an object modeling formalism

(75) Inventors: Philippe Larvet, Forges Les Bains (FR); Patrick Fontaine, Paris (FR)

Correspondence Address: SUGHRUE MION, PLLC, 2100 PENNSYLVANIA AVENUE, N.W., SUITE 800, WASHINGTON, DC, 20037, US

(73) Assignee: ALCATEL

(21) Appl. No.: 11/455,683

(22) Filed: Jun. 20, 2006

(30) Foreign Application Priority Data
Jun. 21, 2005 (FR) 0551697

(51) Int. Cl. G06F 9/44

(52) U.S. Cl. 717/104; 717/106

(57) ABSTRACT

There is disclosed a method of producing a new web service, comprising the steps of: decomposition of data, for example a scenario and/or a use case into modeling elements of the new web service, conforming to an object modeling formalism; creation of an internal object model from the modeling elements; and transformation of modeling elements of the internal object module into modeling elements of an external metamodel. The latter step may be accompanied by a step of generating a code or a step of creating an XMI model via an XMI generator. The invention also concerns a computer program product adapted to implement the method of the invention and a computer file obtained by the method.

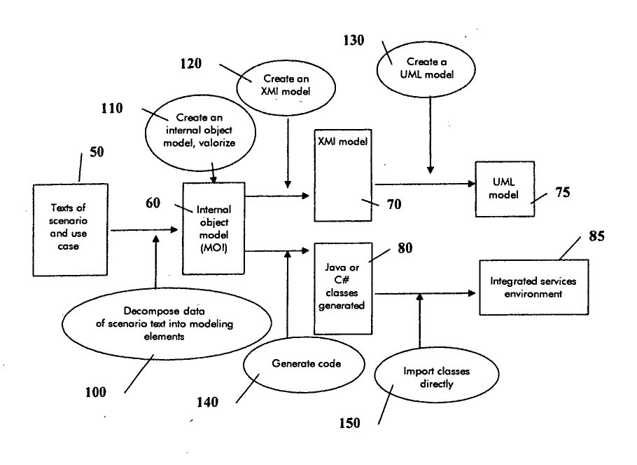

### BACKGROUND OF THE INVENTION

1. Field of the Invention

The present invention concerns a method of providing a new web service, a computer program product adapted to implement that method, in particular a use case assistant, and a computer file obtained by that method.

2. Description of the Prior Art

Hereinafter, unless otherwise indicated, the following terms are used with the indicated meaning:
“Electronic data processing application”: any program, or any set of programs adapted to operate conjointly, the object of which is to render services to their users.
“Class”: the class concept commonly manipulated in modeling formalisms and object-oriented programming languages and in particular the aggregation of data and processes (respectively attributes and methods) adapted to work together in an electronic data processing application. In object-oriented languages, each type of object is defined by its class. A class represents all of the objects sharing the same attributes, operations, methods, relationships and semantics.
“Line”: an expression or series of expressions of a symbolic language supplying particular information to a destination program, for example to the compiler.
“Container”: in object-oriented programming, an object that comprises other objects, such as a dictionary, and provides operations for accessing its content. It may also be a component comprising other components.
“Source code”: text written in a programming or description language that is then compiled into machine language in order to be executed by a hardware electronic data processing platform or interpreted by a software environment or interpretation hardware.
“Code”: this term refers interchangeably to source code and to compiled code.
“Compilation”: the action of translating a description expressed in a programming language to the native language of an electronic data processing hardware platform prior to its execution by that electronic data processing hardware platform.
“Declarative”: data combined without the order in which it is to be used either indicated or necessary. If that order is indicated, the representation is no longer declarative but procedural. The two concepts generally overlap, in the sense that a language may have declarative portions and procedural portions.
“DTD”: document type definition, designating a document logical structure model for fixing the elements to constitute the document and the nature of the links to connect those elements. The term “scheme” is also used.
“Code generation”: the automatic or semi-automatic production of source code for an electronic data processing application by means of a generator, obtained from an abstract description of a software application supplied to the generator and controlling the generation process. Following analysis of the description, this process constructs the expected output code. The description is generally expressed in a language of higher level than that in which the code is to be produced. Thus a language is often chosen that is as close as possible to natural human language, either in graphic form or in text form. The generator can therefore be used without needing to know the formalism of the programming language used in the generated code.
“Heritage”: relationship linking two classes in which a “base class” inherits properties (attributes and methods) from a “mother class”, enabling the former to enrich its own definition with that of the latter, whilst retaining all its original characteristics. A heritage is enriching (the properties of the inherited class are added to the inheriting class) and not impoverishing (not all the properties of the mother class can be inherited).
“HUTN”: human-usable textual notification, referring to an OMG (Object Management Group) standard for creating and modifying text format models with a human-readable syntax that was designed to be generic, automatable and comprehensible to the user. HUTN is recognized as being “simpler” and manifestly more readable than XMI because it is “user” oriented, being similar to languages such as Java, C++ that are known in the art.
“Instance”: an occurrence, an example, an individual member of a type or a class. A member of a class is commonly referred to by the synonymous terms “object” and “instance”.
“Programming language”: formalism for describing actions to be executed by a computer. These descriptions are executed by the computer after compilation or interpretation. An electronic data processing application is described using one or more programming languages. The term “language” refers to all the representation formats used to describe some or all of the software in order to contribute directly or indirectly to their actual construction.
“Metalanguage”: a language taking for its subject matter another language and formalizing it.
“Metamodeling”: the specification of a modeling language using another modeling language (metalanguage), a metamodel being a model representing the syntax of a language. The term “modeling” refers to the abstract representation of a statement, a problem or a system, performed on the one hand with the aim of comprehending and of communicating that comprehension and on the other hand with the aim of solving the problem or of concrete implementation of the system.
“Model Driven Architecture” (MDA): a set of OMG specifications concerning a development process using a series of models that integrate a plurality of dimensions of the project and extend from the functional model to the source code model. These models conform to the UML standard. The progress from one model to the other comprises progressive enrichment of the specifications of the application and uses transformations authorized by the UML metamodel.
“Object-oriented modeling”: a particular type of modeling in which the modeling elements are classes, objects, attributes, methods, associations, etc., as opposed to “functional modeling”, in which the modeling elements are processing functions and data streams. See also “UML”.
“MOF”: Meta-Object Facility, a metamodeling language proposed by the OMG and used to specify the syntax of UML and other modeling languages.
“OMG”: Object Management Group, an organization whose objects include defining standards to guarantee the mutual compatibility of applications programmed using object-oriented languages (cf. http://www.omg.org).
“Object”: in modeling or object-oriented programming, a class instance consisting of a set of data (the inherent defining data of the class) and procedures used to manipulate the data.
“Object-oriented”: refers for example to a model, a language, an application or application elements whose component parts are classes and objects. For example, an object-oriented language is a programming language in which the basic components are classes, the instances whereof—the objects—live dynamically in an electronic data processing program that uses them.
“Package”: firstly, a set of modeling elements (classes or other packages) that are grouped together in order to be re-used or to improve the organization of a model. Once the model has been coded in the programming language, the package designates a directory (a file) of the computer that contains classes or other packages.
“Object-oriented programming”: a particular type of programming using an object-oriented language (for example Java, C++, C# or Eiffel) for manipulating classes and objects, as opposed to non-object-oriented or “standard” programming, which manipulates only simple data structures and separate processing “functions” (for example programming in C, COBOL, FORTRAN).
“Web service”: an application accessible on the INTERNET, via a standard interface, that can interact dynamically with other applications using communication protocols, for example based on XML, independently of the operating system and the programming languages used.
“SGML”: a standardized language for describing the relationships between the content of an electronic data processing document and its structure.
“Stereotype”: a type of modeling element that extends the semantics of the metamodel. Stereotypes must be based on certain types or classes existing in the metamodel. Stereotypes can extend the semantics, but not the structure of pre-existing classes and types. Some stereotypes are predefined in UML, others may be defined by the user. Together with “tagged values” and “annotations”, stereotypes constitute one of the three mechanisms for extending UML.
“UML”: unified modeling language, a modeling notation (rather than a modeling language) using objects, enabling the components of an object system to be determined and presented during its development, as well as generating the system documentation, where appropriate. UML is currently the OMG standard. It results from merging the work of Jim Rumbaugh, Grady Booch and Ivar Jacobson, and is evolving in various ways.
“XMI”: XML model interchange, for specifying rules of correspondences between metamodels and “schemes”. XMI is the OMG standard that links the world of models and the XML world of the World Wide Web Consortium (W3C). It is used to represent UML models in the form of XML files.
“XML”: an evolution of SGML that in particular enables designers of HTML documents to define their own markers, with the aim of personalizing the structure of the data.

Object modeling is known in the art and consists in creating a representation of elements of the real world in terms of classes and objects, independently of any programming language. For example, classes of objects are determined, their inherent data and the functions that use them are isolated. There are various formalisms. UML is one of those formalisms (and is in fact more like a catalog of notations). The UML notation became the OMG standard during the 1990s.

Object-oriented languages each constitute a specific way to implement the class concept. In particular, an object formalism is used to define a problem at a “high level of abstraction” without entering into the specifics of a given language. The UML formalism offers a tool for easily representing a problem in graphic form, making it more accessible to the various players in its solution. In this respect, it is desirable for an object formalism to be defined as rigorously as possible and it should preferably be uniquely defined, in order to minimize ambiguities.

To solve a given problem, the first step is typically to arrive at an abstract conception of an object model. The model is then implemented using an object-oriented language (such as C# or Java).

Also known in the art are web services (WS) which are accessible from any Internet terminal and are increasingly used to generate simple and re-usable applications.

From the point of their complexity, these WS can be divided into two categories: elementary WS and composite WS.

Elementary WS provide a basic service, comparable to those appearing in mathematical libraries, and contains a low level of data transformation, including few algorithms. Translation services are generally considered as elementary WS, for example.

On the other hand, composite WS are able to provide a high-level service and have a plurality of access and data transformation levels, resulting from the cooperation of a plurality of elementary services. Composite services are sometimes called “orchestrated services” (or “interaction processes”), referring to the required orchestration of the elementary services involved. Reservation services and secure payment services are examples of orchestrated composite WS.

Although elementary services can be established and deployed relatively easily in standard environments known in the art, such as Apache/Axis or .NET platform, it would nevertheless be beneficial to have an adapted environment enabling the production and deployment of composite WS obtained by the orchestrated aggregation of existing services.

However, an environment of that kind would give rise to problems with aggregating and orchestrating heritage services, with their interaction and with the manner in which they would have to be executed to meet their objectives and provide the end service, guaranteeing functional coherence of that service.

In this regard, diverse aggregation techniques exist at present. Although, in the industry, there is as yet no consensus on a common language, there are two languages considered to be complementary:
WSBPEL (Web Services Business Process Execution Language) or BPEL, which describes interactions between WS, including the application logic and the order of the interactions; and
WS-CDL (Web Services Choreography Description Language), which describes messages exchanged between WS, including the order of and constraints on those exchanges.

However, using BPEL is not the only way to describe an application logic: Java or C# can also be used.

There is therefore a need for a method of producing a new web service that guarantees the functional cohesion of the service and does not impose constraints linked to the final implementation language.

### SUMMARY OF THE INVENTION

To this end, the invention proposes a method of producing a new web service, comprising the steps of: decomposition of a text description into modeling elements of the new web service, conforming to an object modeling formalism; creation of an internal object model from the modeling elements; and transformation of modeling elements of the internal object module into modeling elements of an external metamodel.

Preferred embodiments of the method of the invention include one or more of the following features:
in the decomposition step, the text description comprises a scenario and/or a use case;
the decomposition step comprises a grammatical and/or semantic analysis of the data;
the decomposition step further comprises the identification, in the use case: of a general description of the new web service; and existing web services liable to be used by that service;
the decomposition step further comprises: the identification of actors involved in the new service, from the use case; and the extraction of inputs-outputs of the new service, from the general description of the new web service;
the decomposition step further comprises a reorganization of phases of the scenario;
the decomposition step further comprises a production of logical phrases from reorganized phrases of the scenario;
the external metamodel is an XMI model and the transformation step is a step of creation of the XMI model via an XMI generator;
the method comprises, after the step of creating the XMI model: a step of creating a UML model from the XMI model created;
the method comprises, during or after the transformation step: a step of generating a code;
the step of creating the internal object module comprises a step of valorization of a data structure of the internal object module and the data structure comprises a plurality of clauses, each of these clauses is associated with one or more modeling elements of the formalism, and each of these clauses is entirely declarative;
each of said clauses relates to a single modeling element;
each of said clauses comprises a code relating to the modeling element to which it relates and characteristics relating to that modeling element;
some of said clauses comprise characteristics relating to a container of the modeling element to which it relates;
the formalism of the object modeling is the UML formalism;
one of the modeling elements of the formalism is a package, a use case, a class, an attribute, an association, or a heritage.

The invention also concerns a computer program product adapted to implement the method of the invention.

The invention further concerns an electronic data processing file obtained by the method of the invention.

### BRIEF DESCRIPTION OF THE DRAWING

Other features and advantages of the invention will become apparent on reading the following detailed description of embodiments of the invention given by way of example only and with reference to examples and to the single FIGURE of the appended drawing, which is a diagram of certain steps of one embodiment of a method of the invention.

### DETAILED DESCRIPTION OF EMBODIMENTS OF THE INVENTION

The invention proposes a method of producing a new web service, a computer program product adapted to implement that method and an electronic data processing file obtained by that method.

The method of the invention comprises a first step of decomposing a text description (typically a scenario and a use case) into modeling elements of an object modeling formalism, for example the UML formalism. The scenario and the use case describe the detailed working of the future “interaction process”, in terms of interactions between the operations of existing services. The use case is similar to a general description, whereas the scenario relates to a detailed, functional description of a particular case, as is known in the art. If necessary, the method can use a plurality of scenario texts.

The scenario and the use case may be expressed in the form of semi-formal texts during or prior to this first step. This step preferably uses a grammatical and/or semantic analysis. It is during this first step that, if necessary, the generation description of the new web service and existing web services liable to be used by the new service are identified.

The method further comprises a step of creating an internal object model (MOI) from modeling elements. This MOI is used for stacking, and is preferably masked, i.e. transparent for the user.

There follows a step of transformation of modeling elements of the internal object model into modeling elements of an external metamodel. For example, this operation may be accompanied by a step of generation of code in any object language (Java, C++, C#, Ada, etc) or of creation of an XMI model.

Using the MOI guarantees functional cohesion of the future service, i.e. of the affair process, and ensures that transformations from one model to another go well. To this end, the service construction mechanism is preferably based on the MDA approach. Note that the approach chosen is agnostic (because of the use of modeling elements in the object sense). Furthermore, the descriptions contained in the data (use case/scenario) are functional. Consequently, the method does not induce any constraints linked to the final implementation language.

Using an MOI also proves advantageous if it is required to produce easily not only object models, for example conforming to UML, but also source programs, in any object language. The MOI then plays the role of a multilingual interlocutor. In this regard, it is particularly advantageous for the MOI to conform to a specific data structure, particularly well adapted to the representation of UML models or to easy generation of source programs.

Once produced, these source programs can then be deployed. There is thus obtained an environment in which the final composed service can be deployed easily, to make it available to end users.

A preferred embodiment of the method of the invention is explained hereinafter by means of an example in a first part of the description. In this first part of the description, the emphasis is on describing the steps of decomposition of data and of creation of the MOI. Then, in a second part of the description, a data structure that is particularly advantageous for the MOI is described in more detail. That data structure conforms to a notation referred to hereinafter as the “FIL” notation (FIL standing for “Format Interchange Language” or “Formal Internal Modeling Language”). The third part of the description is devoted to the generation of source code and to the deployment of services.

I. Description by Means of an Example of the Method of the Invention Implemented by a Use Case Assistant

The general concepts referred to above are described next in relation to a simple affair process example.

It is assumed that a library of web services comprises a plurality of elementary services:
a message transmission service, for sending SMS messages, faxes or electronic mail to given recipients;
a directory service, i.e. a general service for obtaining data specific to a given user, for example his electronic mail address or a list of his contacts; and
a user preferences service, which manages the preferences associated with each user.

I.0 Description of the New Service

Referring to the FIGURE: using the elementary components described above, it is now assumed that it is required to set up a new service, which a first actor, an analysis, describes imprecisely through the following use case 50:

Use Case:

The name of the new service is: Broadcast Message. With this new service, the user wants to broadcast a message to several receivers, according to their messaging preferences. The new service uses some existing services but, at this level, I, analyst, ignore their exact names . . .

Scenario: (Description of the New Service)

The user gives his name, and the new service gets his corresponding contact list. Then, for each contact on this list, the new service gets the type of messaging corresponding to the contact, and according to this type, it sends a SMS, a Fax or an e-mail to the contact.

A use case assistant, adapted to implement the method according to the invention, effects a decomposition 100 of the above data into modeling elements of the new web service, conforming to an object modeling formalism, for example UML.

This decomposition 100 preferably comprises a plurality of transformations, that will be described hereinafter.

Thanks to the above, somewhat imprecise description, the use case assistant executes a series of step-by-step transformations until it obtains 120, 140 elements of an external metamodel 70 such as XMI or a source code 80 corresponding to the new service that is compilable, executable and ready to be deployed.

I.1 First Transformation of the Text Corresponding to the New Service into a Semi-Formal Model

A first transformation liable to be effected by the assistant consists in a rearrangement of the text in order to impart to it a form that can be “processed” by a computer (this is referred to in the art as “machinable” form). This transformation may comprise two sub-steps: a first sub-step of reformulation and a second sub-step of filling in the semi-formal model.

The first sub-step of reformulation of the text comprises a grammatical analysis of the text. This analysis is effected by an appropriate grammatical analysis module of the assistant, capable of effecting reconstructions of phrases, for example.

In this regard, note that there are known in the art tools for effecting a grammatical analysis of a text, for example Grammatica, which is a grammar and spelling checker for texts in French and English. In addition to suggestions, it provides explanations. Grammatica analyzes the function of the words (text and grammatical links, homophones and homographs, synonyms and definition in French). See the site www.zdnet.fr. Another example is the tools from Lexiquest, which perform text analysis and text mining: www.lexiquest.com.

The grammatical analysis module of the assistant is typically able to:
distinguish clearly the “use case” portion of the data from the “scenario” portion,
identify in the “use case” portion the following sub-portions:
   name of the new service,
   general description of the new service, and
   identification of the existing services liable to be used for designing the new service, and
in the “scenario” portion:
   decompose the text into separate phrases,
   reorganize these phrases in order to impart to them a first programming instruction turn of phrase.

After the above operations, a result is obtained, for example:

Use Case

Name of the new service: Broadcast Message.

General description: [With this new service,] the user wants to broadcast a message to several receivers, according to their messaging preferences.

Existing services used: The new service uses some existing services but, [at this level, I, analyst, ignore their exact names.]=at this step, they are still unknown.

Scenario

Detailed Description:
the user gives his name,
the new service gets the contact list of the user
for each contact of this list:
   the new service gets the type of messaging corresponding to the contact,
   according to the type of messaging:
   the new service sends a SMS, or
   the new service sends a Fax, or
   the new service sends an e-mail to the contact.

The second sub-step entails a detailed extraction of the pertinent information in the text in order to fill in the semi-formal model, which is then used to generate the source code belonging to the new service.

Using an appropriate grammatical extractor, the following operations are effected.
In the “use case” portion:
   identification of the name of the new service,
   identification of the actors: initial actor and final actor (more than one, if appropriate),
   the extraction of the general description of the service (if possible),*
   the extraction of the main input-outputs of the service, typically expressed in the form “the user gives the service . . . ”, “the service returns to the user . . . ”, etc.
In the “scenario” portion:
   From separate phrases, the generation of “logical phrases”, i.e. ether independent phrases or portions of phrases intended to become instructions,
   The identification of programming elements necessary (for example “if . . . then . . . else”, “switch . . . case”, “for each . . . ” etc.).

The results of these operations are stored in the corresponding fields of the semi-formal model, for example, as shown below.

Use Case for Messaging Business Process

Actors

The actors are: the User (message broadcaster) and the Receivers.

Use Cases

Use cases impacting the Actor: User (message broadcaster)

Use case name: Broadcast Message

Service name: Messaging Business process

Description: The User wants to broadcast a message to several Receivers, according to their messaging preferences.

Inputs: The User gives to the service the following data:
his sender's name,
the message.

Outputs: The service returns to the User:
no specific data.

Exceptions: No exception for now.

Existing services used: The new service uses some existing services but, at this step, they are still unknown.

Scenario

Scenario for the new service: Broadcast Message
The new service gets the sender's contact list from the users
name.
For each contact of this list:
get the type of messaging corresponding to the contact
according to the type of messaging:
if Sms:
   send a SMS to the contact
if Fax:
   send a Fax to the contact
if Email
   send an e-mail to the contact

This kind of semiformal description has two advantages in particular: a user can read it and it is practical for it to be processed by computer at this stage. Three sorts of elements can be added at this stage to enable a computer to use the description:
the names or identifiers of the existing services to be used,
the names and signatures of the methods (in the object sense) to be used by those services,
the names and types of parameters used by those methods.

In this embodiment and this example, these elements are added during a second transformation, described hereinafter. However, embodiments can be envisaged in which these elements would be assigned by default or directly by the user himself (this latter situation would constitute a non-automatic mode of operation).

I.2 Finalization of the Formal Model

The first transformation used a grammatical analysis. That described next is based rather more on a semantic analysis. To be able to describe XMI type services, the existing (heritage) services are described in the library of services in WSDL, for example, as is known in the art (on this topic see www.w3.org and in particular www.w3.org/TR/wsdl).

On the basis of the WSDL description of a given web service, a dedicated module of the use case assistant preferably executes the following operations:
it reviews the pseudo-instructions (i.e. the semi-formal instructions) of the scenario;
it extracts from those instructions the “conditions of service”, i.e. the requirements concerning the services that have to be adapted to existing services;
it compares those conditions with the signatures and parameters of the service methods (given that they are described in WSDL);
it replaces a condition by the “true” signature of the method of the service if a satisfactory match is found between the original requirement and the signature of a method belonging to a heritage web service.

If necessary, this transformation module can additionally complete the “existing services used” information of the semi-formal model.

Use Cases

...

Existing services used: The new service uses the following existing services:
Directory Service,
Messaging Service,
User Preference Service.

Scenarios

Scenario for the new service: Broadcast Message
The new service gets the sender's email address by invoking the operation GetEmailAddress of Directory Service, with the parameter sender's name.
The new service gets the sender's contact list by invoking the operation GetMyContactList of Directory Service, with the parameter sender's name.
For each element of the sender's contact list, the new service works as follows:
get the messaging type by invoking the operation GetMessagePreference of User Preference Service, with the parameter contact name,
according to the messaging type:
if SMS:
   invoke the operation SendSMS of Messaging Service, with the parameters contact Mobile phone number and message
if Fax:
   invoke the operation SendFax of Messaging Service, with the parameters contact Fax number and message
if e-mail:
   invoke the operation SendMail of Messaging Service, with the parameters contact Email address and message

Note that the operations Sendmail, SendSMS, etc. are modeling elements in the sense of the invention.

Following these new additions, the assistant can, if necessary, test the coherence of the description obtained by comparing the signatures and parameters selected by the second transformation module with the original WSDL descriptions of the heritage directory services. A specific command of the assistant is used, for example, to find and store the service descriptions required by the original text of the scenario, for comparing them afterwards to the WSDL descriptions chosen by the automatic module of the first transformation.

Following this coherence test, the developer can, for example, correct the choices effected by the assistant and impose his own choices of services instead.

I.3 Production of the Internal Object Model of the Scenario

The method according to the invention used by the assistant comprises a central step 110 of creating an internal object model 60 from the modeling elements of the new web service.

For example, this step can use a built-in text—formal language transformation pattern as well as WSDL—formal language transformation patterns. Thus the rule of these patterns is to translate the semi-formal text of the use case and the scenario, as well as the descriptions of heritage WSDL services, into a formal MOI.

For example, the MOI 60 can use a specific data structure (FIL) explained in more detail in the second part of the description. As mentioned above, the MOI is used in particular to generate code easily, at the same time as ensuring functional coherence at the time of the various transformations involved and therefore the coherence of the final service.

Before “applying” the text—MOI transformation (i.e. text—FIL transformation in the present embodiment), an elementary pattern is preferably used for processing by keywords that operates on the scenario text resulting from the second transformation in order to transform pseudo-instructions that can be read by the user into instructions that can be executed by a computer.

To this end, non-significant words such as “the”, “service”, “invoke”, “operation”, “parameter”, etc. can be eliminated first. The keyword processing pattern can then, for example, replace predefined keywords (such as “get”, “with”, “from”, “of”, etc.) and reorganize each pseudo-instruction into a final programming instruction form.

Consider, for example, the following phrase from the above scenario:
The new service gets the senders email address by invoking the operation GetEmailAddress of Directory Service, with the parameter sender's name.
   This phrase has a known match in the “developer” world. For example:
getting (cf. “gets”) data “A” by invoking the operation “B” written by the developer: A=B( );
the operation “B” of the service “S” is written: S.B( ).
   Thus in the developer world the above phrase is translated:
sender_email_address=DirectoryService.GetEmailAddress (sender_name);
   There results, after the operation carried out by the keyword processing module:
   Scenario for the new service: Broadcast Message
   sender_contact_list=DirectoryService.GetMyContactList (sender_name);
   for each element of sender_contact_list:
   messaging_type=UserPreferenceService.GetMessagePreference (contact.name);
   switch (messaging_type):
   case SMS: messagingService.SendSMS (contact.Mobile_phone_number, message);
   case Fax: MessagingService.SendFax (contact.Fax_number, message);
   case Email: MessagingService.SendMail (contact.Email_address, message);

It now remains to apply the text—MOI transformation pattern, which represents a third level of transformation (in fact at this level it is more of a translation), producing with the FIL format the complete semi-formal text of the use case and the scenario. There is obtained in this way (extract):

* Formal Internal Object Model Language
* for the new service Broadcast Message
*----------------------------------------
* package declarations
p: Messaging Business Process
p: MessagingService
p: UserPreferenceService
p: DirectoryService
* class declarations
c: MessagingService, MessagingService
c: DirectoryService, DirectoryService
...
* association declarations
r: MessagingBusinessProcess (1..1) uses (1..1) DirectoryService
(...)
r: DirectoryService (1..1) uses (1..n) ContactInfo
* attribute declarations
a: Name:string, ContactInfo
(...)
a: theDirectoryService:DirectoryService, MessagingBusinessProcess
a: type_of_messaging:String, MessagingBusinessProcess
* operation declarations
o: GetUserProfile(userName:string) :UserProfile; UserPreferenceService
o: GetMyContactList (username:string) :ArrayOfContactInfo,
DirectoryService
* operation declaration + operation detailed description
o: BroadcastMessage (String sender_name, String message);
MessagingBusinessProcess display_message (“The user wants to
broadcast a message to several Receivers”) sender_contact_list =
theDirectoryService.GetMyContactList (sender_name) for
(i<sender_contact_list.Length)
type_of_messaging =
theUserPreferenceService.GetMessagePreference
(sender_contact_list [i] .Name)
switch (type_of_messaging)
case Sms: theMessagingService.SendSMS
(sender_contact_list [i] .Mobile.message)
case Fax: theMessagingService.SendFax
(sender_contact_list [i] .Fax.message)
case Email: default: the MessagingService.SendMail
(sender_contact_list[i] .EMail,message)
end switch
end for
* end of FIL

The lines preceded with an * are comments. The key letters followed by a colon “:” distinguishing modeling elements of the new service (for example the relationship “MessagingBusinessProcess (1..) uses (1..1) DirectoryService”), where applicable involving existing services (in this example “DirectoryService”).

The FIL notation reflects the internal model of the new service, expressed in a formal manner and stored, for example, in a proprietary database of the use case assistant. This notation is explained in the next part of the description.

II. Data Structure of the Internal Object Model Conforming to the FIL Notation

### II.0 CONTEXT, DEFINITIONS

By way of a preliminary to the detailed description of a data structure to the FIL format, it is necessary to point out that the UML notation, as currently standardized, has no text notation for representing the object models. Only a graphical representation is proposed in the standard for the various UML diagrams (diagram of classes, interactions, states—transitions, etc.) but no text counterpart of that graphical representation is proposed in the UML standard. XMI was not intended to be “readable”, i.e. not understandable to a human user. Moreover, it is not self-contained. The HUTN syntax was designed with the aim of being comprehensible by the user. HUTN remains a procedural language, i.e. the order of the lines is of critical importance for the interpretation of this language.

Given this background, it is particularly desirable to have a data structure that can be processed by a computer, that can be used to represent UML models, and that can easily generate source programs, in any object language. It is equally desirable for this data structure to be simple and light to manipulate, and, once reified, comprehensible by the user.

The term “data structure” means first of all the actual structure of the data as manipulated in the internal representation of the program that exploits it. However, the term “data structure” also refers to the structure of the information present in a file, as it appeared at the time of editing or printing the file. This file could be a reification file of the above “data structure”, for example, as understood in its first sense.

### II.1 GENERAL CHARACTERISTICS OF THE FIL DATA STRUCTURE

This data structure is the representation of an object modeling formalism comprising a plurality of modeling elements. The expression “representation of an object modeling formalism” means that the data structure can be exploited in particular to provide a graphical representation conforming to that formalism. The latter could, for example, be restricted to the UML notation, in which case the modeling elements are the elements conventionally manipulated by UML, i.e. packages, classes, attributes, operations, associations, cardinalities, heritages, etc.

The proposed data structure comprises a plurality of clauses, for example logical clauses that can be valorized or manipulated by a program. Each of these causes is associated with one or more modeling elements of the formalism and each of these clauses is entirely declarative.

This data structure is simple. Once the data structure has been reified, for example in a file, each clause becomes a line of that file, using a formal notation. Now, given that each clause is entirely declarative, the order of these clauses and consequently the order of the lines of the file does not affect their interpretation. This simplifies the comprehension of the file by a user.

Each clause preferably corresponds to only one modeling element, which simplifies both the algorithmic processing of the data structure and the comprehension by the user of a file constructed from that data structure.

Moreover, each clause is preferably self-contained, to enable interpretation thereof without needing to access some other cause for that purpose.

The data structure is represented by a high-level formal notation. This enables the use of simple and integrated data processing methods. For example, methods for transcribing and representing UML models, which are usually described in the form of diagrams and graphical schemas associated with non-formal text and the structure of which is not standardized. This data structure is also used, by means of appropriate electronic data processing, to produce easily both object models conforming to UML and source programs in any object language (Java, C++, C#, Ada, etc.). This will be described in detail later in the description.

This data structure is therefore advantageously substituted for the alternatives currently proposed which, being based on XMI/XML or on HUTN, offer no tool that is simultaneously simple, light and easily able to generate code.

The FIL data structure is described hereinafter with reference to a reification file of that data structure, for reasons of intelligibility. It nevertheless remains the case that a line of that file may correspond to a logical clause that can be interpreted by an electronic data processing program.

### II.2 FORMAL CHARACTERISTICS OF THE FIL DATA STRUCTURE

Each FIL line of the file preferably comprises a code relating to the modeling element to which it relates, where appropriate a single character specifying the type of element described, for example, “a” for attribute, “c” for class, “h” for heritage, “r” for relationship, etc. Each line further comprises a body comprising characteristics relating to that element. This produces a structure suited to use of the line by an electronic data processing application. The presence of the corresponding code further facilitates identification of the element by the user.

Consider by way of example the following phrase: “a cat eats mice”. This phrase establishes a relationship between “a cat” and “mice”. That relationship may be coded, using FIL notation, in the following line:

r: cat (1..1) to eat (1..n) mice

in which the “r” specifies that the modeling element in question is a relationship and (1..1) and (1..n) refer the cardinalities respectively corresponding to (a) cat and (some) mice.

Other examples are described in detail hereinafter.

The body of certain FIL lines preferably comprises two portions, the first portion comprising characteristics intrinsic to the modeling element (for example a type value for an attribute) and the second portion comprising characteristics relating to a container of the modeling element. Thus an element is declared linked directly to its container. However, the declaration relates primarily to said modeling element and the container could be the subject of an independent declaration. Accordingly, the corresponding declarations (i.e. of the clauses or of the file lines) remain independent. This yields a file structure thereafter enabling an application to reconstruct hierarchies between the diverse elements.

The detailed examples hereinafter relate to a particular embodiment in which the FIL lines are sorted by type, for reasons of readability, for example in the following indicative order: packages, classes, attributes, operations, associations, heritages. This makes it easier to learn the elements and their relationships. It should nevertheless be borne in mind that these lines may be declared or stored in memory in any order. The codes specifying the elements being reduced to a single lowercase letter, in the first addition of the line. A colon “:” follows immediately, in turn followed by a space, as shown in the above example. Moreover, a comma (if there is one) is always followed by a space. Other syntax rules may apply, as will be apparent in these examples.

If appropriate, a data structure production and/or electronic data processing tool may be integrated into the assistant, or at least the assistant may comprise the functions of that tool.

The tool may valorize the data structure, i.e. assign corresponding values to the data. It may further access that structure, i.e. be able to extract values from it and/or to manipulate the data structure (replace its values). In particular, the tool interprets the FIL lines of a file. If necessary, it may be provided with routines for correcting or interpreting syntax errors and omissions. The lines can be stored in memory in any order.

### II.3 EXAMPLES

### Example 1

An attribute is declared as follows:

a: attribute name, class name

where “attribute name” and “class name” link logically to the name of the attribute and of the class to which the attribute belongs, the comma serving as a separator.

### Example 2

a: attribute name:type, class name

In this example, an attribute is declared with its type. There is preferably no space either before or after “:type”. The standard types are as is usual in the art, for example “String”, “boolean”, “int” or “integer”, “Date”. Other types may be used, including the names of the classes described in the notation itself. For example:

a: attribute name:class one, class two

### Example 3

a: attribute=value, class name

Here an initial value is assigned to the attribute. There is preferably no space either before or after the = symbol. It may be noted that the tool can advantageously interpret an incomplete syntax (as in the above example, where the attribute type is missing). For example, the tool can be designed to interpret and to find the appropriate type automatically, taking account of several criteria. The criteria may be based on the name of the attribute itself, for example, such as “number”, “amount”, “meter”, etc., the tool then proposing the “integer” type by default. The criteria may also be based on the value associated with the attribute. For example, if the value is “true” or “false”, the type proposed is “boolean”; if the value is numerical, the type proposed is “integer” or “real” according to whether or not it contains digits after a decimal point; if the value is between double quotation marks (thus “...”), the type proposed is “String” (signifying “character string”), etc. Thus in many cases mentioning the type may be superfluous, because the tool can establish the type.

### Example 4

a: attribute:type=value, class name

In this example, the syntax is complete.

### Example 5

c: class name[, package name]

Here a class is declared, together with [, the package to which it belongs]. Here the square brackets indicate the optional reference to the package name. For example, if the package is not mentioned and no package has previously been encountered, the class could be stored systematically in a given package, for example the “p_system” package, which is then considered the highest level package. That package may exist by default, for example, and be used only if a class has no destination package. If necessary, if the package name is not mentioned, the class can be stored in the last package “p:” encountered in the FIL file, by the exploitation electronic data processing tool. Note that the concept of order is involved here only to compensate a syntax error on the part of the user. Similarly, the explicit declaration of a class with “c:” may be omitted by adapting the tool so that the classes are recognized and declared automatically on the basis of attributes, operations, associations and heritages. The tool uses the code “c:” for the FIL file generated as output, however. On the other hand, the code “c:” could advantageously be used explicitly to declare a class with stereotype (see below) or to force a class to belong to a package.

### Example 6

c: <<stereotype>>class name[, package name]

Here, a class is declared with a stereotype [, and the package to which it belongs]. If necessary, a stereotype may also be associated with the packages, attributes, operations and associations.

### Example 7

h: class name 1 is-a class name 2

In this new example, a heritage is declared, using a keyword. The keyword used, which is necessary for the declaration of the heritage, is “is-a”. It should be noted that the code “h:” may be omitted. If it is not present, the code can be added automatically by the tool, which interprets the FIL line as relating to a heritage element because of the presence of the corresponding keyword. The line can therefore be entered simply as in the following example: “square is-a graphical element”.

### Example 8

o: operation name, class name

Here an operation is declared. Only one comma is necessary, followed by a space.

### Example 9

p: package name[, surrounding package]

Here a package is declared, as belonging to the surrounding package with the name “surrounding package” The mention of the surrounding package is optional.

### Example 10

r: class name 1 (1..1) association name (1..n) class name 2

This example illustrates one way to specify the cardinality. Two numbers are used, one at each end of the association and in brackets. The instruction begins, as appropriate, with “(1”, “(0”, “(m” or “(n” and ends with “1)” or “n)”. A space is provided before and after. With regard to the name of the association or the class, this may be any name, consisting of one or more words, for example. Once again, a space is provided before and after the name. Furthermore, if the association name is “is-made-up-of” or “contains”, an aggregation could automatically be generated in a UML tool used subsequently. Moreover, just like the code “h:”, the code “r:” is not obligatory, the tool being adapted to interpret an association as such, if required, by identifying a codification of cardinality. For example, the line “system (1..1) is-made-up-of (1..n) sub-system” could be interpreted directly as describing an association “is-made-up-of” (aggregation).

### Example 11

u: use case name, package name

The declaration of a use case may also be used to declare a function of the system that may correspond to one or more use cases.

Consider the following example:

c: cat, example

c: mice, example

r: cat (1..1) to eat (1..n) mice

In the UML notation, the above clauses are represented as follows. The classes “cat” and “mice” are typically symbolized by labels. Corresponding cardinalities may appear nearby. The above relationship (r: cat (1..1) to eat (1..n) mice) is symbolized by an arrow linking the labels.

II.4 Valorization of the FIL Format Data Structure

The simplicity of the FIL notation enables a data structure (or a file) to be created reflecting that notation, where applicable directly from the analysis of a text written in natural language. The structure created could therefore serve as a basis for the creation of a UML object or for the generation of a source program, for example.

Referring again to the FIGURE, the step 110 of creating the internal object model 60 is reflected in a valorization of the data structure of the MOI.

“Valorization” means that values corresponding to data are stored (for example in the random-access memory of the computer or on a mass storage medium). As a result, a data structure 60 can be processed on a computer.

In particular, a modeling element can be represented (i.e. transformed by a computer) into a corresponding clause of the data structure 60. Note that different algorithmic variants may be envisaged. For example, if a modeling element is isolated (in the decomposition step 100), it is transformed into a corresponding clause (step 110). Alternatively, elements can be transformed into clauses after each of them has been identified in the step 100. The decomposition step 100 and the creation step 110 can thus be at least in part concomitant.

III. Transformation into Modeling Elements of an External Metamodel (Creation of a New Model or Code Generation)

III.1 Creation of a New Model, for Example an XMI Model

Referring again to the FIGURE, the method may comprise, during or after the transformation step 120, 140, a step 120 of an XMI generator creating an XMI model 70 from the data structure associated with the MOI 60. The XMI generator could operate in accordance with a principle similar to that used by the code generator, for example, as described hereinafter. Having accessed the content of the data structure, the generator stores that structure in its own internal memory and then transforms its content in accordance with transformation rules that are specific to it, for which there are parameters that can be set, and which depend on the matches to be established between two metamodels: on the one hand, the metamodel of the FIL data structure itself (input structure), and on the other hand the metamodel of the XMI, Java, C# or C++ data structure (expected output structure), for example. Thus the generation tool merely applies to a data structure stored internally transformation rules matching a modeling element of a given metamodel with a modeling element of another metamodel.

In this regard, there are tools, such as Model-In-Action from Sodifrance (see www.mia-software.com) that are used to construct these generators: the two metamodels are described using UML, and then the transformation rules using a high-level language, and transformers-language generators are obtained very quickly in this way.

Here, the model 70 is generated from the data structure 60 previously valorized. A graphical UML model 75 can then be produced from the XMI model 70 during a model production step 130. The production of a graphical UML model from an XMI model is in itself known in the art (tools such as Objecteering® from Softeam or Rhapsody® from i-Logix can be used for this, for example).

III.2 Code Generation

The method of the invention may further comprise a step 140 of generating a code 80 during or after the transformation step 120, 140. During the code generation step, the data structure is stored, for example, and then its content transformed in accordance with transformation rules for which there are parameters that can be set and which depend on the required matches between two metamodels, in a similar manner to that described above with reference to the XMI generator.

At the end of this step, Java or C# classes are generated. These may advantageously be exploited in an integrated services development environment (SDE) 85. A services development environment is an object application development environment that knows how to read Java or C# source classes directly, for example. In this regard, the step 150 is a simple step of importing these classes 80, correctly generated in a target format directly by the environment 85.

It should be noted that there are prior art tools for generating the code from a “proprietary” internal model (for example Rational Rose® from IBM, Objecteering® or Rhapsody®). The internal object models in question are generally specific to each manufacturer; they are not published, not modifiable and not exportable.

To effect a code generation, existing code generators employ descriptions of a level higher than the level of the code to be produced. They often rely on modeling, such as UML, and are used to generate the code thereof in a given programming language.

In practice, the assistant enables the developer to choose the target language (for example C# or Java). The assistant then proceeds to a transformation toward the target language, using an appropriate pattern. Transformation principles useful for producing transformation patterns are described, for example, in “Design Patterns”, Erich Gamma, Richard Helm, Ralph Johnson, John Vlissides, Addison-Wesley Professional, first edition, 1995.

For example, the C# source code generated by the assistant from the above scenario/use case is given hereinafter.

```
//------------------------------------------
// C# Class Name : MessagingBP
//
// Creation Date : 11-15-XXXX
// Generated by XXXXX
//------------------------------------------
<%@ WebServce Language=“c#”
Class=“PoweredBy.BusinessProcess.Messaging.MessagingBP” %>
using System;
using System.Web.Services;
using PoweredBy.WebServiceProxy;
namespace PoweredBy.BusinessProcess.Messaging
{
  [WebService]
  public class MessagingBP:System.Web.Services.WebService
  {
    // Attributes
    private DirectoryService theDirectoryService;
    private MessagingService theMessagingService;
    private UserPreferenceService theUserPreferenceService;
    private String sender_email_address;
    private ContactInfo[ ] sender_contact_list;
    private String call_subject;
    private msgTypePref messaging_type;
    private int i;
    // Constructor
    public MessagingBP( )
    {
      theDirectoryService = new DirectoryService( );
      theMessagingService = new MessagingService( );
      theUserPreferenceService=new UserPreferenceService( );
    }
    // Operations
    [WebMethod] [SoapRpcMethod]
    public void BroadcastMessage (String sender_name, String message)
    {
      sender_contact_list =
theDirectoryService.GetMyContactList (sender_name);
      for (i=0; i<=sender_contact_list.Length; i++)
      {
      messaging_type =
theUserPreferenceService.GetMessagePreference
(sender_contact_list [i] .Name);
      switch (messaging_type) {
        case msgTypePref.Sms: {
    theMessagingService.SendSMS
    (sender_contact_list [i] .Mobile,message);
          break; }
      (...)
      } // end switch
      } // end for
    } // end of operation
  } // end of class
} // end of namespace
```

Once the source code has been generated, for example in the form of a “.asmx” file, it can be tested immediately by a test environment connected to the assistant.

III.2 Deployment

The developer engineer can now deploy the final service, by choosing the required type of deployment, for example Microsoft IIS, Apache/Axis or BPEL.

Then, using an appropriate pattern, the final source code of the new service is moved into an appropriate directory. The corresponding proxies are then produced and deployed. The new service is then available on the Internet or the Intranet, in accordance with the chosen deployment characteristics.

Thus the invention is used to transform an imprecise original text, written by the user, into software that is compilable, executable, testable and ready to be deployed.

The overall approach of the assistant using the method of the invention should be borne in mind, which aggregates a plurality of beneficial elementary approaches and enhances the production of web services. Thanks to the invention, the services are produced faster, at lower cost and with better quality. In particular:
thanks to the “interaction process” approach, a new web service can be seen as an orchestrated aggregation of a plurality of existing elementary services;
thanks to the multi-actor approach, the various actors—analyst, developer, etc—can use the assistant at different levels;
thanks to the multiform approach, the assistant can read, transform and reverse semi-formal or vague texts;
thanks to its agnostic approach, the use case and the scenario of the target affair processes are expressed independently of the final implementation language; and

thanks to the “modeling element” and MDA approach, incorporated and masked, a coherent MOI is constructed that is concealed from the user, who has only to manipulate high-level descriptions.

However, the invention is not limited to the embodiments described above and lends itself to many other variants that will be readily apparent to the person skilled in the art.

1. A method of producing a new web service, comprising the steps of:
decomposition of a text description into modeling elements of said new web service, conforming to an object modeling formalism;
creation of an internal object model from said modeling elements; and
transformation of modeling elements of said internal object module into modeling elements of an external metamodel.

2. The method of claim 1, wherein, in said decomposition step, said text description comprises a scenario and/or a use case.

3. The method of claim 2, wherein said decomposition step comprises a grammatical and/or semantic analysis of the data.

4. The processing method of claim 3, wherein said decomposition step further comprises the identification, in the use case:
of a general description of said new web service; and
existing web services liable to be used by said service.

5. The processing method of claim 4 wherein said decomposition step further comprises:
the identification of actors involved in said new service, from said use case; and
the extraction of inputs-outputs of said new service, from said general description of said new web service.

6. The processing method of claim 4, wherein said decomposition step further comprises a reorganization of phases of said scenario.

7. The processing method of claim 6, wherein said decomposition step further comprises the production of logical phrases from reorganized phrases of said scenario.

8. The method of claim 1, wherein said external metamodel is an XMI model and said transformation step is a step of creation of said XMI model via an XMI generator.

9. The method of claim 8, comprising, after said step of creating said XMI model:
a step of creating a UML model from said XMI model created.

10. The method of claim 1, comprising, during or after said transformation step:
a step of generating a code.

11. The method of claim 1, wherein said step of creating said internal object module comprises:
a step of valorization of a data structure of said internal object module;
and wherein:
said data structure comprises a plurality of clauses;
each of said clauses is associated with one or more modeling elements of said formalism; and
each of said clauses is entirely declarative.

12. The method of claim 11, wherein each of said clauses relates to a single modeling element.

13. The method of claim 12, wherein each of said clauses comprises a code relating to the modeling element to which it relates and characteristics relating to said modeling element.

14. The method of claim 11, wherein some of said clauses comprise characteristics relating to a container of the modeling element to which it relates.

15. The method of claim 1, wherein the formalism of the object modeling is the UML formalism.

16. The method of claim 1, wherein one of the modeling elements of the formalism is:
a package;
a use case;
a class;
an attribute,
an association; or
a heritage.

17. A computer program product adapted to implement the method of claim 1.

18. A computer file obtained by the method of claim 1.
